(19) United States
(12) Patent Application Publication
(10) Pub. No.: US 2020/0195107 A1
(43) Pub. Date: Jun. 18, 2020

(54) METHOD AND DEVICE FOR HOLDING A LAMINATED CORE IN POSITION TOGETHER WITH CONDUCTOR ELEMENTS RECEIVED THEREIN

(71) Applicant: Miba Automation Systems Ges.m.b.H., Laarkirchen (AT)

(72) Inventors: Andreas Falkner, Wels (AT); Mladen-Mateo Primorac, St. Pölten (AT); David Scherrer, Gmunden (AT)

(21) Appl. No.: 16/643,496

(22) PCT Filed: Aug. 8, 2018
(86) PCT No.: PCT/AT2018/060183

§ 371 Date: Feb. 28, 2020

(30) Foreign Application Priority Data
Sep. 1, 2017 (AT) A50736/2017

(51) Int. Cl. H02K 15/085; H02K 15/00

(52) U.S. Cl. CPC H02K 15/085; H02K 15/0087; H02K 15/0037

(57) ABSTRACT

The invention relates to a method as well as a device for positioned holding of at least one layer (9, 10) of several conductor elements (3, 4) arranged distributed over the circumference of a laminated core (2) and formed as bars in relative position with respect to the laminated core (2) accommodating the conductor elements (3, 4) in each case in a receiving groove (5) extending between a first front face (7) and a second front face (8). For this purpose, all conductor elements (3, 4) of the at least one layer (9, 10) are each acted upon at their end portions (11, 12; 13, 14) protruding beyond the laminated core (2) by at least one pressure element (21, 22), which is adjustable in the radial direction, of a pressure device (20). The laminated core (2) is held in position by a holding device (17).

The invention relates to a method and a device for the positioned holding of a laminated core including at least one layer accommodated in the laminated core, which layer is made up of several conductor elements arranged spread over the circumference of the laminated core for forming a stator or a rotor of an electric machine.

It was the object of the present invention to provide a method and a device by means of which a user is able to achieve safe handling processes of the laminated core including the laterally displaceable conductor elements accommodated in the receiving grooves without the conductor elements being able to change their prepositioned relative location.

This object is achieved by means of a method and a device according to the claims.

The method according to the invention serves for positioned holding of at least one layer of several conductor elements arranged distributed over the circumference of a laminated core and formed as bars in relative position with respect to the laminated core accommodating the conductor elements in each case in a receiving groove extending between a first front face and a second front face to form a stator or rotor of an electrical machine, in which
at least one of the conductor elements is inserted into each of the receiving grooves,
each of the at least one conductor elements is arranged in a longitudinally displaceable manner in the receiving groove accommodating the at least one conductor element, and
the laminated core is protruded beyond on at least one of its front faces by end portions of the conductor elements, wherein
the laminated core is held positioned by a holding device, and
all conductor elements of the at least one layer are each acted upon at their end portions protruding beyond the laminated core by at least one pressure element, which is adjustable in the radial direction, of a pressure device with a pressure force built up by the at least one pressure element, and all conductor elements are thus held positioned relative to the laminated core in the direction of the longitudinal extension of the receiving grooves.

The advantage of the method steps selected here is that, hence, after the introduction and loading of the laminated core with the individual conductor elements, they can also be held stationarily relative to the laminated core already held positions by the pressure elements of the pressure device. By means of the holding device, the laminated core can not only be held positioned but handling processes can also be carried out therewith. If conductor elements are not held in a relative position with respect to the laminated core, they could be unintentionally displaced due to their free and longitudinally displaceable accommodation in the individual receiving grooves, resulting in faulty or unusable stators or rotors.

Due to the circumferential arrangement of the conductor elements, a circumferential application or build-up of compressive forces on all conductor elements must also be ensured in order to create a secure relative positional fixation between the individual conductor elements and the laminated core even in the event of tolerance-related deviations. Since a compressive force is applied to all the conductor elements around their circumference, tolerance differences can be better compensated for, thus reliably preventing unintentional longitudinal displacement of individual conductor elements in the receiving grooves. If possible foreign objects, such as grains, insulation residues or tolerance-related differences in the thickness of the insulation layer are also arranged or occur, hence a secure axial longitudinal positioning of each of the individual conductor elements over the entire circumference can nevertheless be achieved. Once the compressive forces have been built up and all the conductor elements have been held and fixed relative to the laminated core, this unit consisting of laminated core and conductor elements can be used to carry out subsequent manipulation operations, for example by means of the holding device. In this way, the alignment and position no longer needs to be taken into account, as unintentional displacement of the conductor elements with respect to the laminated core is reliably prevented. This compressive force-based fixing position of the individual conductor elements is particularly advantageous if the longitudinal axis of the conductor pack has a vertical orientation and otherwise, due to the free longitudinal accommodation of the conductor elements in the receiving grooves, a relative displacement of the latter cannot be prevented when removing the laminated core from a supported rest.

A method variant in which the laminated core is held positioned by a holding arm of the holding device and, in the course of this, holding elements that are located on the holding arm and are adjustable in the radial direction are pressed against an inner surface of the laminated core, is also advantageous. In this way, a secure and predetermined alignment in the axial direction can be achieved when the laminated core is picked up by the holding arm of the holding device. Due to the radial adjustment of the holding elements against the inner surface of the laminated core, a perfectly secure holding and predetermined alignment of the longitudinal axis of the laminated core can be achieved. This can for example be carried out in the form of a three-jaw chuck.

Moreover, an approach is advantageous according to which the passive transfer of the laminated core including the conductor elements is carried out in a position of a longitudinal axis extending between the two front faces having a perpendicular alignment and, subsequently, the laminated core including the conductor elements is pivoted such that the longitudinal axis is brought into a horizontal alignment. Hence, the laminated core including the conductor elements accommodated therein, can be supported with one of its front faces in a horizontal position, for example on a tool carrier or transport trolley, and at the same time, the individual conductor elements protruding beyond the laminated core can be positioned by gravity, preferably in a self-acting manner. Thus, the possibility of dispensing with additional alignment operations is created, wherein after the laminated core was picked up, all conductor elements can be held fixed in their position relative to the laminated core by the applied pressure force or by the applied pressure forces.

A further advantageous approach is characterized in that the at least one pressure element of the pressure device is held in a fixed position predetermined for this purpose with respect to the holding device, in particular its holding arm, on said holding device, in particular on said holding arm. Hence, it is ensured that the at least one pressure element of the pressure device is also arranged stationarily with respect to the holding device. Possible relative alignment adjustments of the position of the pressure element in relation to the holding device, in particular its holding arm, can be made depending on the projection of the end portions of the conductor elements beyond the laminated core before the application of the pressure force.

An embodiment variant in which the at least one pressure element is accommodated in a support element preferably formed continuously across the circumference and the support element is held in a fixed position predetermined for this purpose with respect to the holding device thereon, is also advantageous. By providing at least one support element, the arrangement and positioning of the pressure element(s) can hence be carried out more easily as considered across the circumference.

Another approach is characterized in that each one of the conductor elements is acted upon with the pressure force acting in the radial direction by a separate pressure element. It is thus ensured that each of the individual conductor elements also can be acted upon by a pressure force for secure relative clamping.

Moreover, an approach is advantageous according to which the at least one pressure element is formed from an elastically expandable or elastically deformable material. Hence, by the selection of the material of the pressure element, a safe build-up of the pressure forces can be achieved as considered across the circumference by its elastic properties.

A further advantageous approach is characterized in that the at least one pressure element is formed from a self-recovering material. Hence, easy removal of the built-up pressure force of the pressure forces, which have previously been exerted and/or applied onto the conductor elements, can be carried out without additional adjusting means. Hence, in an easy manner, the pressure force or pressure forces can first be built up, which then, after the buildup by the self-recovering properties of the pressure element results in an easy release of the previously clamped conductor elements.

An embodiment variant, according to which the at least one pressure element is formed as a hose or ring that is continuous across the circumference, is also advantageous. By forming the pressure element as a hose or ring, hence, considered across the circumference the pressure force can be applied to each one of the conductor elements easily without additional alignment or orientation works.

Another approach is characterized in that the hose is pressed against the end portions protruding beyond the laminated core by a pressure medium placed in its inside. By introducing the pressure medium into the inside of the hose, hence, as considered across the circumference a quick and comprehensive buildup of the pressure forces onto all conductor elements can be carried out. Alignment operations of the pressure element to the respective arrangement of the conductor elements in the laminated core can hence be dispensed with.

Moreover, an approach according to which all conductor elements of the at least one layer are pressed against the laminated core on a side facing away from the longitudinal axis of the laminated core by the pressure force built up by the at least one pressure element, is also advantageous. By pressing the individual conductor elements against the laminated core on the side facing away from the longitudinal axis, hence, these are pressed outwardly in the radial direction, whereby sufficiency may be achieved with at least one pressure element on the radially inner side of the first layer of conductor elements.

A further advantageous approach is characterized in that all conductor elements of the at least one layer are pressed against the laminated core on a side facing the longitudinal axis of the laminated core by the pressure force built up by the at least one pressure element. Hence, with at least one pressure element located outwardly in the radial direction, the pressure force onto the outermost layer of conductor elements in the radial direction can be built up and it can thus be pressed towards the longitudinal axis in the radial direction.

A method variant according to which several conductor elements, which are arranged immediately behind one another and/or immediately next to one another in the radial direction, of the layers are accommodated in the laminated core and all conductor elements of each one of the layers are together pressed against the laminated core by the pressure force built up by the at least one pressure element either on a side facing away from the longitudinal axis of the laminated core or on a side facing the longitudinal axis of the laminated core, is also advantageous. It is hence allowed for that several layers of conductor elements arranged behind one another in a receiving groove can press against the laminated core with a pressure element arranged either outwardly or inwardly with respect to the conductor elements.

Another approach is characterized in that several conductor elements, which are arranged immediately behind one another and/or immediately next to one another in the radial direction, of the layers are accommodated in the laminated core and all conductor elements of each one of the layers are pressed together by at least one first pressure element and by at least one second pressure element in the radial direction in each case. With the arrangement of the pressure element on both sides as seen in the radial direction, these can securely be pressed to one another and/or against one another in the radial direction, whereby an even better tolerance compensation and a more secure holding of the conductor elements to be held positioned can be achieved.

A further advantageous approach is characterized in that the individual conductor elements of the at least one layer, prior to the application of the pressure force of the at least one pressure element, are aligned in a positioned manner in an axial direction with respect to the laminated core. Hence, even prior to the positioned holding of the conductor elements with respect to the laminated core, a defined relative position of the individual conductor elements with respect to the laminated core can be determined.

The device according to the invention serves for positioned holding of at least one layer of several conductor elements arranged distributed over the circumference of a laminated core and formed as bars with respect to the laminated core accommodating the conductor elements in each case in a receiving groove extending between a first front face and a second front face to form a stator or rotor of an electrical machine, and for carrying out the method. The device comprises the following features:
a holding device is provided, by means of which holding device the laminated core can be held in a positioned manner, and
a pressure device with at least one pressure element, which is formed to be adjustable in the radial direction, by means of which at least one pressure element a pressure force can be applied to the end portions protruding beyond the laminated core of all conductor elements.

The advantage achieved thereby consists in that, hence, after the introduction and loading of the laminated core with the individual conductor elements, they can also be held stationarily relative to the laminated core already held positions by the pressure elements of the pressure device. By means of the holding device, the laminated core can not only be held positioned but handling processes can also be carried out therewith. If conductor elements are not held in a relative position with respect to the laminated core, they could be unintentionally displaced due to their free and longitudinally displaceable accommodation in the individual receiving grooves, resulting in faulty or unusable stators or rotors.

Due to the circumferential arrangement of the conductor elements, a circumferential application or build-up of compressive forces on all conductor elements must also be ensured in order to create a secure relative positional fixation between the individual conductor elements and the laminated core even in the event of tolerance-related deviations. Since a compressive force is applied to all the conductor elements around their circumference, tolerance differences can be better compensated for, thus reliably preventing unintentional longitudinal displacement of individual conductor elements in the receiving grooves. If possible foreign objects, such as grains, insulation residues or tolerance-related differences in the thickness of the insulation layer are also arranged or occur, hence a secure axial longitudinal positioning of each of the individual conductor elements over the entire circumference can nevertheless be achieved. Once the compressive forces have been built up and all the conductor elements have been held and fixed relative to the laminated core, this unit consisting of laminated core and conductor elements can be used to carry out subsequent manipulation operations, for example by means of the holding device. In this way, the alignment and position no longer needs to be taken into account, as unintentional displacement of the conductor elements with respect to the laminated core is reliably prevented. This compressive force-based fixing position of the individual conductor elements is particularly advantageous if the longitudinal axis of the conductor pack has a vertical orientation and otherwise, due to the free longitudinal accommodation of the conductor elements in the receiving grooves, a relative displacement of the latter cannot be prevented when removing the laminated core from a supported rest.

It can further be advantageous if the pressure device comprises at least one support element preferably formed continuously across the circumference, said at least one support element being held on the holding device in a position stationary with respect thereto, and the at least one pressure element is accommodated in the support element. By providing at least one support element, the arrangement and positioning of the pressure element(s) can hence be carried out more easily as considered across the circumference.

Another embodiment is characterized in that the pressure device comprises a first support element and a second support element, wherein preferably both support elements are formed continuously across the circumference, and at least one first pressure element is arranged in the first support element and at least one second pressure element is arranged in the second support element, and that the second support element is arranged on the outer side as well as spaced apart from the first support element in the radial direction. With the arrangement of the pressure element on both sides as seen in the radial direction, these can securely be pressed to one another and/or against one another in the radial direction, whereby an even better tolerance compensation and a more secure holding of the conductor elements to be held positioned can be achieved.

A further possible embodiment has the features that the at least one pressure element is formed from an elastically expandable or elastically deformable material and/or from a self-recovering material. Hence, by the selection of the material of the pressure element, a safe build-up of the pressure forces can be achieved as considered across the circumference by its elastic properties. This further allows for easy removal of the built-up pressure force of the pressure forces, which have previously been exerted and/or applied onto the conductor elements, can be carried out without additional adjusting means. Hence, in an easy manner, the pressure force or pressure forces can first be built up, which then, after the buildup by the self-recovering properties of the pressure element results in an easy release of the previously clamped conductor elements.

In a further design it is provided for that the at least one pressure element is formed as a hose or ring, said hose or ring being formed continuously across the circumference. By forming the pressure element as a hose or ring, hence, considered across the circumference the pressure force can be applied to each one of the conductor elements easily without additional alignment or orientation works.

Another embodiment is characterized in that at least one first pressure element can apply the pressure force acting on the side facing away from the longitudinal axis of the laminated core. By pressing the individual conductor elements against the laminated core on the side facing away from the longitudinal axis, hence, these are pressed outwardly in the radial direction, whereby sufficiency may be achieved with at least one pressure element on the radially inner side of the first layer of conductor elements.

A further preferred embodiment is characterized in that at least one second pressure element can apply a second pressure force acting in the direction towards the longitudinal axis of the laminated core. Hence, with at least one pressure element located outwardly in the radial direction, the pressure force onto the outermost layer of conductor elements in the radial direction can be built up and it can thus be pressed towards the longitudinal axis in the radial direction.

For the purpose of better understanding of the invention, it will be elucidated in more detail by means of the figures below.

These show in a respectively very simplified schematic representation:

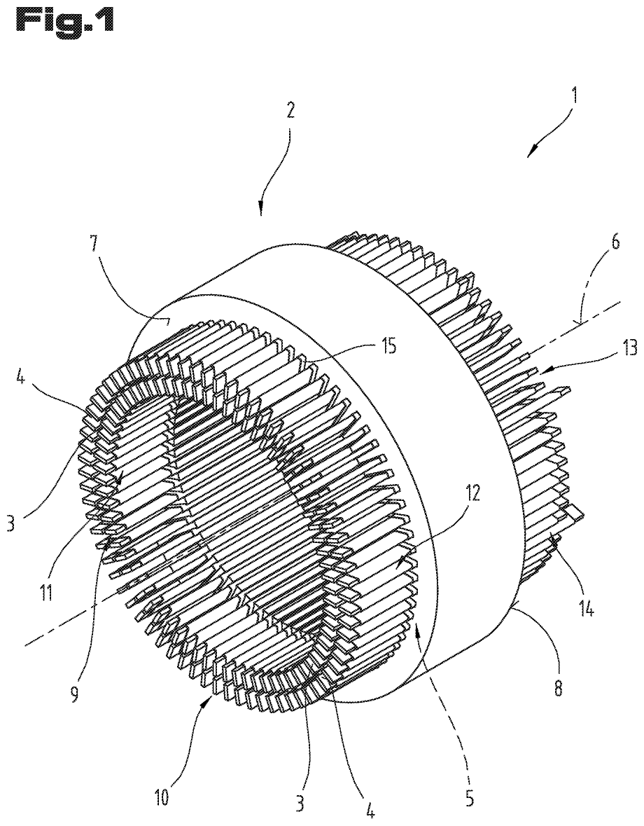

FIG. 1 a graphic depiction of a laminated core with a plurality of conductor elements accommodated therein;

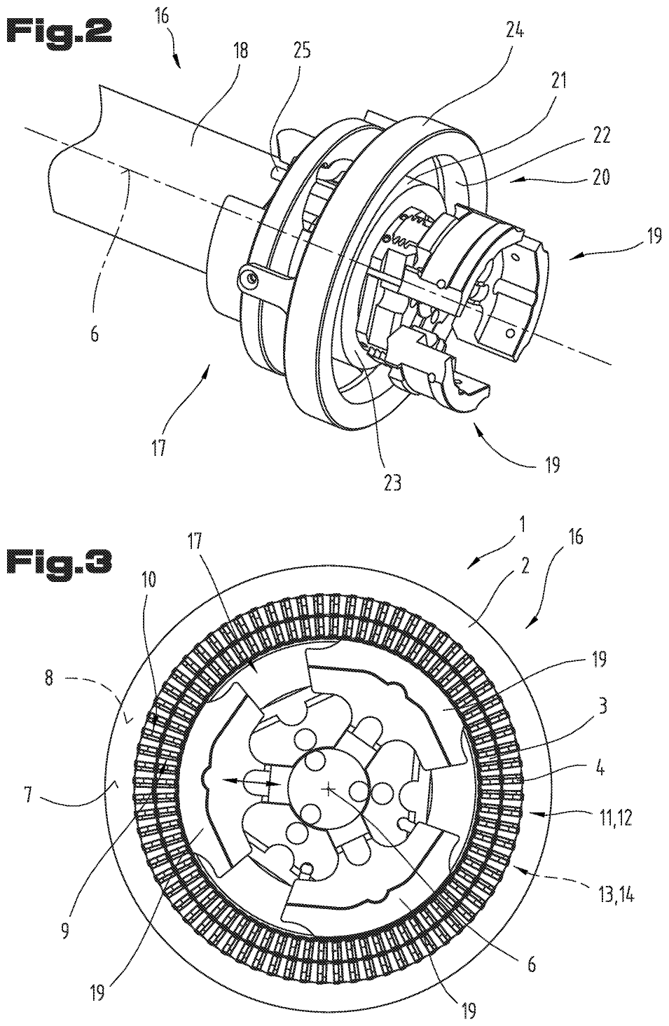

FIG. 2 a possible design of a device for positioned holding of at least one layer of conductor elements in relative position with respect to the laminated core, without the laminated core and the conductor elements as well as in graphic depiction;

FIG. 3 the device according to FIG. 2 with the laminated core and the conductor elements held positioned, in a front view;

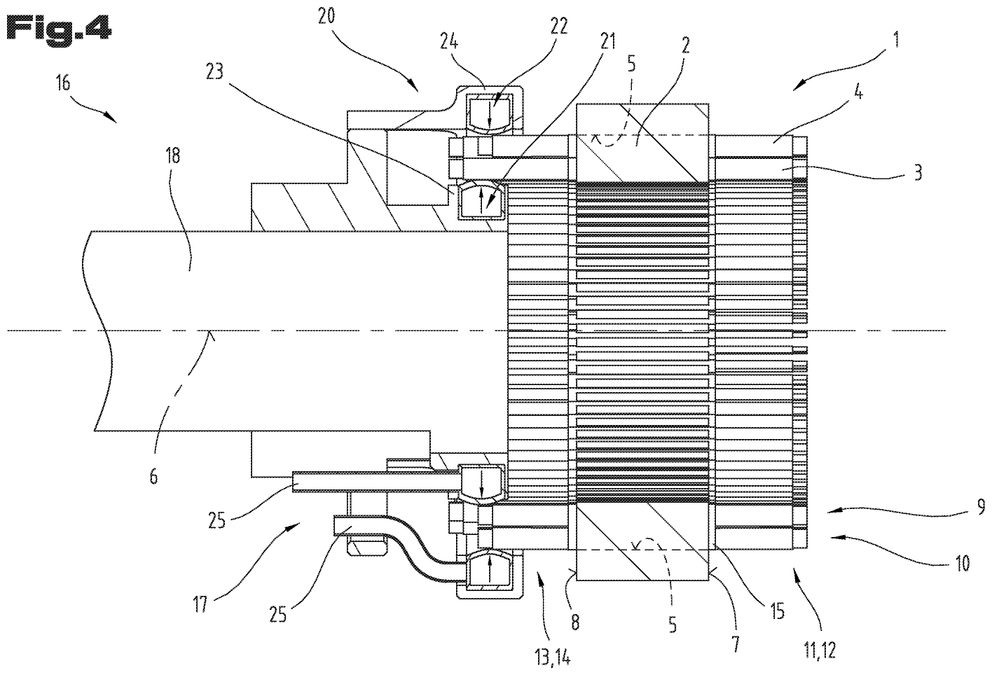

FIG. 4 a detail of the pressure device according to FIGS. 2 and 3 without holding elements and in axial section;

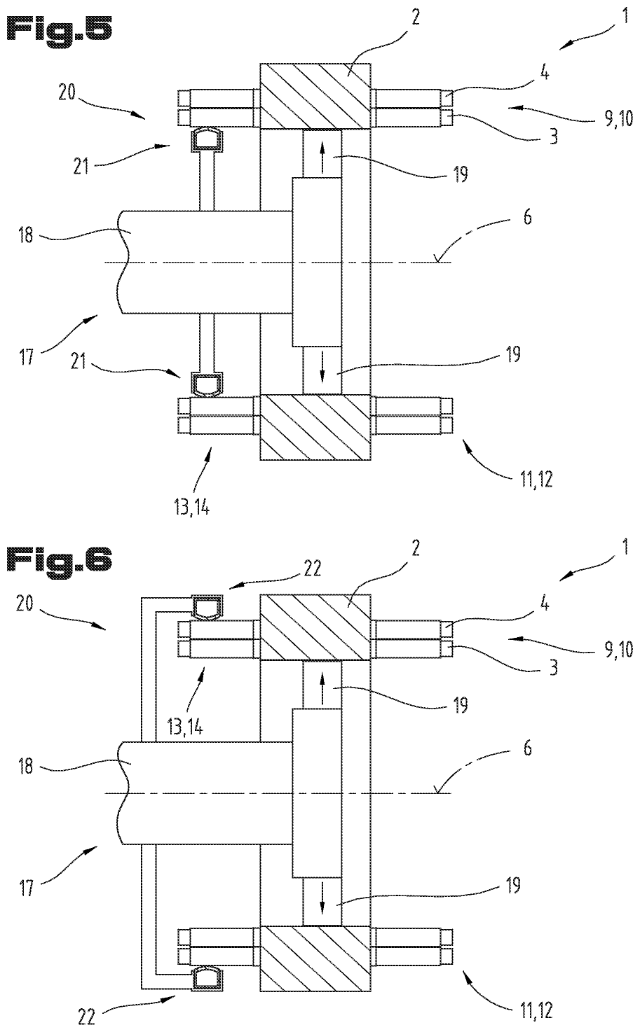

FIG. 5 a further possible arrangement of the pressure element of the pressure device, in axial section and stylized representation;

FIG. 6 Another possible arrangement of the pressure element of the pressure device, in axial section and stylized representation.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The term “particularly/in particular” is hereinafter understood such that it may refer to a possible, more specific embodiment and more detailed specification of a subject matter or a method step, but does not necessarily have to represent an obligatory, preferred embodiment of the latter or an obligatory approach.

FIG. 1 shows a possible formation of a stator 1 for forming an electric machine not depicted in more detail. However, it would also be possible to analogously apply and carry out the description and embodiment below also to a rotor for forming an electric machine. The description below refers only to a stator 1, but it may equally relate to a rotor.

The assembly and a plurality of manufacturing steps of the stator 1 can be carried out in an automated manner, largely even in a fully-automated manner, in several manufacturing stations, preferably in a complex manufacturing plant.

In principle, the stator 1 comprises a laminated core 2 as well as a plurality of conductor elements 3, 4 to be accommodated therein for creating a rotating magnetic field by means of coils.

In the present exemplary embodiment the individual conductor elements 3, 4 are configured in the latter's non-deformed initial situation as straight rods. The rods typically have a rectangular cross-section up to a square cross-section as well as a longitudinal extent and are formed by an electrically-conductive material. This material is usually a copper material. Therefore, these can also be referred to as profile rods. In a known manner, the conductor elements 3, 4, with the exception of contact areas formed at them can be surrounded by an insulation layer not depicted or designated in more detail.

A plurality of receiving grooves 5 are arranged or configured in the laminated core 2 spread over the circumference for forming electric coils and windings formed thereby, in which receiving grooves at least one of the conductor elements 3, 4, but preferably at least two of the conductor elements 3, 4, is or are respectively accommodated or arranged. The receiving grooves 5 can extend in an axial direction as well as preferably in a parallel alignment with respect to a longitudinal axis 6 defined by the laminated core 2. However, it would also be possible to select non-parallel alignment of the receiving grooves 5 with the conductor elements 3, 4 to be accommodated therein. In this way, the receiving grooves 5 respectively extend in a direction of the longitudinal axis 6 between a first front face 7 and a second front face 8 arranged spaced apart therefrom.

The receiving grooves 5 respectively have a cross-section of the receiving groove adapted to the cross-sectional dimension of the conductor element 3, 4 or in case of several conductor elements 3, 4 accommodated in the same receiving groove 5 a cross-section of the receiving groove adapted to the cross-sectional dimensions to same.

The laminated core 2 is a pack composed of a plurality of individual metal sheets or sheet metal segments electrically insulated from each other and is limited in a direction of the longitudinal axis 6 by the first front face 7 and the second front face 8 arranged spaced apart from same. Preferably, the two front faces 7, 8 are arranged in parallel to one another as well as running in a plane aligned in a normal direction with respect to the longitudinal axis 6. In the present exemplary embodiment, the pack of the individual metal sheets or the sheet metal segments forms a hollow cylinder having an inner surface and an outer surface.

At least one of the conductor elements 3, 4, but preferably several, in particular two, three, four, five, six or even more conductor elements 3, 4, is arranged in each of the receiving grooves 5. Even eight, ten, twelve or more of the conductor elements 3, 4 may be accommodated. As a minimum variant, one conductor element 3, 4 is provided, whereas in this exemplary embodiment two conductor elements 3, 4 are depicted and described in one respective receiving groove 5. In this way, the conductor elements 3 arranged in a radial direction on the inside form a first layer 9 and the conductor elements 4 arranged in a radial direction on the outside form a second layer 10.

Each of the conductor elements 3 and 4 comprises respectively at its first end a first end portion 11, 12 and comprises respectively at its opposite second end a second end portion 13, 14. In this exemplary embodiment the first end portions 11, 12 protrude beyond the first front face 7 and the second end portions 13, 14 protrude beyond the second front face 8 of the laminated core 2.

The conductor elements 3, 4 accommodated in the individual receiving grooves 5 in the laminated core 2 and usually as yet non-deformed are twisted against or crossed over each other in a known manner in a circumferential direction in the area of the end portions 11, 12; 13, 14 of each of the front faces 7, 8 in one of the downstream manufacturing steps, in order to subsequently thus connect in an electrically-conductive manner a first of the end portions 11 of the first or inner layer 9 to another, corresponding first end portion 11 of the second or outer layer 10. The same can preferably be carried out also with the respective second end portions 13, 14 in the area of the second front face 8.

Furthermore, it may also be advantageous if the individual conductor elements 3, 4, in addition to their insulation layer within the receiving grooves 5, are also surrounded by a separate insulation element 15, preferably along the entire circumference.

The feeding or the inserting of the individual conductor elements 3, 4 in(to) the respective receiving grooves 5 may be done step by step or cycle by cycle, wherein the longitudinal axis 6 of the laminated core 2 in this process is in a horizontal alignment. As the usually non-deformed conductor elements 3, 4 are accommodated longitudinally slidable in the respective receiving grooves 5, the relative position of the conductor elements 3, 4 with respect to the laminated core 2 is to be taken into consideration or ensured during the transfer to a downstream processing station or manufacturing station.

In a positioning step to be carried out preferably before the transfer or passing on to the downstream processing station or manufacturing station, the conductor elements 3, 4 can be aligned in an axial direction with respect to one of the front faces 7, 8. This can be done, for example, by moving the laminated core 2 including the conductor elements 3, 4 already accommodated therein from its preferably horizontal feed position to a vertical positioning position, in which the longitudinal axis 6 of the laminated core 2 has a vertical longitudinal alignment. The laminated core 2 can use a positioning projection for support, wherein the conductor elements 3, 4 in a preferably gravity-induced manner come into flush contact within the individual receiving grooves 5 with one of their end portions 11, 12 or 13, 14 up to a positioning element preferably formed circumferentially. The distance between the positioning projection and the positioning element is to be selected in accordance with the given protrusion of the ends of the conductor elements 3, 4 beyond one of the front faces 7, 8 of the laminated core 2.

This transport position may, for example, be taken on a work carrier movable between individual of the work stations.

The active or passive transfer to a downstream processing station or manufacturing station is now to be carried out in this position of the longitudinal axis 6 having a vertical alignment without changing the relative position of the already prepositioned conductor elements 3, 4 with respect to the laminated core 2.

For this purpose, the subsequently indicated method steps for positioned holding of at least one layer 9, 10 of several conductor elements 3, 4 arranged distributed over the circumference of a laminated core 2 and usually formed as straight bars in relative position with respect to the laminated core 2 accommodating the conductor elements 3, 4 in each case in a receiving groove 5 extending between the two front faces 7, 8, can be carried out optionally using a device 16 presented in FIGS. 2 to 4 or FIGS. 5 and 6 below.

The device 16 shown in FIGS. 2 to 4 and formed or provided for this purpose can be part of a workstation and in this exemplary embodiment comprises a holding device 17 by means of which the laminated core 2 can be picked up and held in a positioned manner. For this purpose, the holding device 17 can comprise a holding arm 18 with holding elements 19 located thereon. Several ones of the holding elements 19 can be provided distributed across the circumference, which can be pressed against the inner surface of the laminated core 2 after the insertion of the holding arm 18 into the inside of the laminated core 2.

The holding device 17 further comprises a pressure device 20 with a number of pressure elements 21, 22 selected depending on the number of layers 9, 10 of conductor elements 3, 4. In case of just one layer 9, 10 of conductor elements 3, 4, sufficiency could be achieved with just one pressure element 21 or 22. By means of the pressure element(s) 21, 22, a pressure force “F” or pressure forces “F” built up by the at least one pressure element 21, 22 can be applied to all conductor elements 3, 4 in each case on their first end portions 11, 12 and/or second end portions 13, 14 protruding beyond the laminated core 2. An approximately equal pressure force should simultaneously act upon or be applied onto all end portions 11, 12 and/or 13, 14. Possible arrangements are described below.

Prior to the application of the pressure force or pressure forces, preferably, as was described above, the individual conductor elements 3, 4 of the at least one layer 9, 10 are to be aligned positioned with respect to the laminated core 2 in the axial direction. The first front face 7 can for example be selected as a reference plane or reference face.

This passive transfer and the insertion of the holding arm 18 with the holding elements 19 can still be carried out in a position having a perpendicular alignment of the longitudinal axis 6 extending between the two front faces 7, 8. Then, the laminated core 2 including the conductor elements 3, 4 can be pivoted such that the longitudinal axis 6 has a horizontal position.

Prior to the pivoting operation, if it is required at all, all conductor elements 3, 4 of the at least one layer 9, 10 are to be held positioned in the direction of the longitudinal extension of the receiving grooves 5 relative to the laminated core 2. This is carried out by means of the pressure device 20.

In order to prevent a relative displacement of the pressure device 20 with respect to the holding device 17, in particular its holding arms 18, the pressure device, in particular the at least one pressure element 21, 22, is to be held or attached thereon in a fixed position predetermined for this purpose. This can be carried out for example by means of separate support elements 23, 24 of the pressure device 20.

In the present exemplary embodiment, two layers 9 and 10 of conductor elements 3 and 4 are provided. In this regard, the individual conductor elements 3, 4 are arranged immediately behind one another in the radial direction. However, it would also be possible to not only arranged several conductor elements 3, 4 immediately behind one another in the radial direction within the same receiving groove 5, but also to arranged several conductor elements 3, 4 immediately next to one another in each layer 9, 10. It is also possible that more than two layers are provided behind one another in the radial direction.

The safest holding and clamping by the pressure element(s) 21, 22 can be achieved, due to tolerances, if at least one of the pressure elements 21, 22 is arranged on each side (outside and inside) of the conductor elements 3, 4, as seen in the radial direction. Accordingly, here, the first pressure element 21 is arranged on the inside with respect to the first layer 9 in the radial direction and the second pressure element 22 is arranged on the outside with respect to the second layer 10 in the radial direction. Hence, the layers 9, 10 and thus the conductor elements 3, 4 arranged immediately behind one another in the radial direction in each case immediately in each case can be pressed against one another.

For fastening and holding the first pressure element 21 as well as the second pressure element 22, here, a first support element 23 and a second support element 24 can be provided. In this case, the pressure elements 21, 22 can be held in a fixed position predetermined for this purpose with respect to the holding device 17 by means of the support elements 23, 24. Moreover, the at least one first pressure element 21 can be accommodated or arranged in the first support element 23 and the at least one second pressure element 22 can be accommodated or arranged in the second support element 24.

In this regard, it is provided for here that the second support element 24 is arranged on the outer side as well as spaced apart from the first support element 23 in the radial direction. Preferably, the support elements 23, 24 can be formed continuously across the circumference. A U-profile can, for example, be selected as the profile shape of the support elements 23, 24. The respective open side is to face the respective layer 9, 10 onto which the pressure force is to be applied.

In the present exemplary embodiment, the pressure elements 21, 22 are formed as a hose preferably 3being continuous across the circumference. Moreover, the material of the pressure elements 21, 22 should be formed to be elastically expandable or elastically deformable. A material additionally having self-recovering properties can also be used preferably. Hence, by means of the elastic properties of the selected material, a tolerance compensation can be provided. Elastomers, rubber, caoutchouc or the like could thus be used.

If the at least one pressure element 21, 22 is formed as a hose, a pressure medium can be inserted into the inside of the hose for the application of the pressure force. Due to the increase in cross-section, the hose is pressed as a pressure element against the end portions 11, 12; 13, 14 which protrude beyond the laminated core 2. For this purpose, each interior of the hose is line-connected via a supply line 25 to a pressure generator not shown in more detail, in order to allow the supply of the pressure medium into the interior as well as the discharge from the interior. Preferably a gaseous and/or a liquid pressure medium can be used. Preferably air, in particular compressed air, can be used as pressure medium.

It would also be possible to form the at least one pressure element 21, 22 as an elastic ring. For this purpose, separate adjustment means would have to be provided in order to carry out the adjustment movement and to be able to build up the pressure force or pressure forces.

Independently thereof, it would also be possible that each one of the conductor elements 3, 4 is acted upon by the pressure force acting in the radial direction by a separate pressure element 21, 22. Accordingly, a plurality of pressure elements are to be provided to be able to build up the individual pressure forces.

Independently thereof, it would also be possible, as is schematically adumbrated in FIGS. 5 and 6, to provide the at least one pressure element 21, 22 merely on one side of the layer 9, 10 or the layers 9, 10. Hence, the end portions 11, 12 and/or 13, 14 protruding beyond the laminated core 2 in each case could be pressed against the laminated core 2. In case of several layers 9, 10, all conductor elements 3, 4 of each one of the layers 9, 10 could together be pressed against the laminated core 2 by the pressure force built up by the at least one pressure element 21, 22 either on a side facing away from the longitudinal axis 6 of the laminated core 2 or on a side facing the longitudinal axis 6 of the laminated core 2. If just one layer 9 or 10 of conductor elements 3 or 4 is provided, the one layer 9 or 10 with all conductor elements 3 or 4 can either be pressed against the laminated core 2 on a side facing away from the longitudinal axis 6 of the laminated core 2 or be pressed against the laminated core 2 on a side facing the longitudinal axis 6 of the laminated core 2.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 stator

2 laminated core

3 conductor element

4 conductor element

5 receiving groove

6 longitudinal axis

7 first front face

8 second front face

9 first layer

10 second layer

11 first end portion

12 first end portion

13 second end portion

14 second end portion

15 insulation element

16 device

17 holding device

18 holding arm

19 holding element

20 pressure device

21 first pressure element

22 second pressure element

23 first support element

24 second support element

25 supply line

1. A method for positioned holding of at least one layer of several conductor elements arranged distributed over the circumference of a laminated core and formed as bars in relative position with respect to the laminated core accommodating the conductor elements in each case in a receiving groove extending between a first front face and a second front face to form a stator or rotor of an electrical machine, the method comprising:
at least one of the conductor elements is inserted into each of the receiving grooves,
each of the at least one conductor elements is arranged in a longitudinally displaceable manner in the receiving groove accommodating the at least one conductor element, and
the laminated core is protruded beyond on at least one of its front faces by end portions of the conductor elements, wherein
the laminated core is held positioned by a holding device, and
all conductor elements of the at least one layer are each acted upon at their end portions protruding beyond the laminated core by at least one pressure element, which is adjustable in the radial direction, of a pressure device with a pressure force built up by the at least one pressure element, and all conductor elements are thus held positioned relative to the laminated core in the direction of the longitudinal extension of the receiving grooves.

2. The method according to claim 1, further comprising the laminated core is held positioned by a holding arm of the holding device and, in the course of this, holding elements that are located on the holding arm and are adjustable in the radial direction are pressed against an inner surface of the laminated core.

3. The method according to claim 1, wherein the passive transfer of the laminated core including the conductor elements is carried out in a position of a longitudinal axis extending between the two front faces having a perpendicular alignment and, subsequently, the laminated core including the conductor elements is pivoted such that the longitudinal axis is brought into a horizontal alignment.

4. The method according to claim 1, wherein the at least one pressure element of the pressure device is held in a fixed position predetermined for this purpose with respect to the holding device, in particular its holding arm, on said holding device, in particular on said holding arm.

5. The method according to claim 1, wherein the at least one pressure element is accommodated in a support element preferably formed continuously across the circumference and the support element is held in a fixed position predetermined for this purpose with respect to the holding device thereon.

6. The method according to claim 1, wherein each one of the conductor elements is acted upon with the pressure force acting in the radial direction by a separate pressure element.

7. The method according to claim 1, wherein the at least one pressure element is formed from an elastically expandable or elastically deformable material.

8. The method according to claim 1, wherein the at least one pressure element is formed from a self-recovering material.

9. The method according to claim 1, wherein the at least one pressure element is formed as a hose or ring that is continuous across the circumference.

10. The method according to claim 9, wherein the hose is pressed against the end portions protruding beyond the laminated core by a pressure medium placed in its inside.

11. The method according to claim 1, wherein all conductor elements of the at least one layer are pressed against the laminated core on a side facing away from the longitudinal axis of the laminated core by the pressure force built up by the at least one pressure element.

12. The method according to claim 1, wherein all conductor elements of the at least one layer are pressed against the laminated core on a side facing the longitudinal axis of the laminated core by the pressure force built up by the at least one pressure element.

13. The method according to claim 1, wherein several conductor elements, which are arranged immediately behind one another and/or immediately next to one another in the radial direction, of the layers are accommodated in the laminated core and all conductor elements of each one of the layers are together pressed against the laminated core by the pressure force built up by the at least one pressure element either on a side facing away from the longitudinal axis of the laminated core or on a side facing the longitudinal axis of the laminated core.

14. The method according to claim 1, wherein several conductor elements, which are arranged immediately behind one another and/or immediately next to one another in the radial direction, of the layers are accommodated in the laminated core and all conductor elements of each one of the layers are pressed together by at least one first pressure element and by at least one second pressure element in the radial direction in each case.

15. The method according to claim 1, wherein the individual conductor elements of the at least one layer prior to the application of the pressure force of the at least one pressure element, are aligned in a positioned manner in an axial direction with respect to the laminated core.

16. A device for positioned holding of at least one layer of several conductor elements arranged distributed over the circumference of a laminated core and formed as bars with respect to the laminated core accommodating the conductor elements in each case in a receiving groove extending between a first front face and a second front face to form a stator or rotor of an electrical machine, and for carrying out the method according to claim 1, comprising:
a holding device, by means of which the laminated core can be held in a positioned manner, and
a pressure device with at least one pressure element, which is formed to be adjustable in the radial direction, by means of which at least one pressure element a pressure force can be applied to the end portions protruding beyond the laminated core of all conductor elements.

17. The device according to claim 16, wherein the pressure device comprises at least one support element preferably formed continuously across the circumference, said at least one support element being held on the holding device in a position stationary with respect thereto, and the at least one pressure element is accommodated in the support element.

18. The device according to claim 16, wherein the pressure device comprises a first support element and a second support element, wherein preferably both support elements are formed continuously across the circumference, and at least one first pressure element is arranged in the first support element and at least one second pressure element is arranged in the second support element, and that the second support element is arranged on the outer side as well as spaced apart from the first support element in the radial direction.

19. The device according to claim 16, wherein the at least one pressure element is formed from an elastically expandable or elastically deformable material and/or from a self-recovering material.

20. The device according to claim 16, wherein the at least one pressure element is formed as a hose or ring, said hose or ring being formed continuously across the circumference.

21. The device according to claim 16, wherein at least one first pressure element can apply the pressure force acting on the side facing away from the longitudinal axis of the laminated core.

22. The device according to claim 21, wherein at least one second pressure element can apply a second pressure force acting in the direction towards the longitudinal axis of the laminated core.
